(19) United States
(12) Patent Application Publication
(10) Pub. No.: US 2015/0109413 A1
(43) Pub. Date: Apr. 23, 2015

(54) VIDEO RECEPTION APPARATUS TO PROVIDE HYBRID SERVICE BASED ON TRANSPORT STREAM SYSTEM TARGET DECODER MODEL

(71) Applicant: Electronics and Telecommunications Research Institute, Daejeon (KR)

(72) Inventors: Kug Jin YUN, Daejeon (KR); Jin Young LEE, Seoul (KR); Won Sik CHEONG, Daejeon (KR)

(21) Appl. No.: 14/512,533

(22) Filed: Oct. 13, 2014

(30) Foreign Application Priority Data
Oct. 21, 2013 (KR) 10-2013-0125592
Jan. 29, 2014 (KR) 10-2014-0011528

(51) Int. Cl. H04N 13/00

(52) U.S. Cl. CPC H04N 13/0059
USPC 348/43

(57) ABSTRACT

Provided is a video reception apparatus to receive hybrid three-dimensional television (3DTV) content that may synchronize a base video, received over a first communication network, and an auxiliary video, received over a second communication network, using a hybrid buffer or a file buffer, and may output the base video and the auxiliary video as a single stereoscopic video.

### CROSS-REFERENCE TO RELATED APPLICATIONS

This application claims the priority benefit of Korean Patent Application No. 10-2013-0125592, filed on Oct. 21, 2013, and Korean Patent Application No. 10-2014-0011528, filed on Jan. 29, 2014, in the Korean Intellectual Property Office, the disclosures of which are incorporated herein by reference.

### BACKGROUND

1. Field of the Invention

Embodiments relate to a video reception apparatus, and more particularly, to a video reception apparatus to provide a hybrid service that may process and synchronize a plurality of signals received via a plurality of paths and may output the plurality of signals as a single signal.

2. Description of the Related Art

With the development in electronic technology, various types of electronic devices, for example, a reception apparatus such as a television (TV), have been developed and distributed.

Currently, as the performance of a TV is enhanced, multimedia contents, for example, three-dimensional (3D) contents or full high-definition (HD) contents, have been serviced. Such types of contents have a relatively large data size compared to existing contents.

A transmission bandwidth used for a broadcasting network may be limited and thus, a size of content transmittable over a current broadcasting network may also be limited. To overcome the limitation, a resolution may need to be reduced, which may result in degrading the quality of video.

To prevent the above issue found in the art, for example, to prevent the degradation in the quality of video, attempts to transmit various types of media data using a variety of transmission environments have been made. However, since a plurality of sets of of data is transmitted via different paths, a reception apparatus may be unaware of whether the plurality of sets of data is related to each other and accordingly, may not perform appropriate synchronizing.

Accordingly, there is a need for a method that may appropriately synchronize various types of contents.

### SUMMARY

Embodiments provide a video reception apparatus that may receive hybrid three-dimensional television (3DTV) contents over a broadcasting network and an Internet protocol (IP) communication network.

Embodiments also provide a video reception apparatus that may compensate for a delay occurring in an IP communication network using a hybrid buffer.

Embodiments also provide a video reception apparatus that may store an auxiliary video to be synchronized with a base video in advance using a file buffer or a local storage.

According to an aspect of embodiments, there is provided a video reception apparatus, including: a first receiver configured to receive a base video over a first communication network; a second receiver configured to receive an auxiliary video over a second communication network; and a hybrid buffer configured to compensate for a delay occurring in the auxiliary video based on a communication state of the second communication network, with respect to the base video.

The video reception apparatus may further include a processing unit configured to synchronize the auxiliary video with the base video based on media pairing information received over at least one of the first communication network and the second communication unit, and to insert the same presentation time stamp (PTS) into the base video and the auxiliary video.

The processing unit may process the base video and the auxiliary video based on the PTS to output the base video and the auxiliary video as a single stereoscopic video.

The second receiver may include a streaming buffer configured to sore the auxiliary video.

The first receiver may include: a first video buffer configured to store a video elementary stream corresponding to the base video; an audio buffer configured to store an audio elementary stream corresponding to the base video; a first pairing buffer configured to store media pairing information for synchronizing the base video with the auxiliary video; and a first system buffer configured to store system information corresponding to the base video and on a program that is in a decoding process.

The first receiver may further include: a first video decoder configured to decode the video elementary stream; an audio decoder configured to decode the audio elementary stream; a first pairing decoder configured to decode the media pairing information stored in the first pairing buffer; and a first system decoder configured to decode the system information stored in the first system buffer.

The second receiver may include: a second video buffer configured to store a video elementary stream corresponding to the auxiliary video; a second pairing buffer configured to store media pairing information for synchronizing the auxiliary video with the base video; and a second system buffer configured to store system information corresponding to the auxiliary video and on a program that is in a decoding process.

The second receiver may further include: a second video decoder configured to decode the video elementary stream corresponding to the auxiliary video; a second pairing decoder configured to decode the media pairing information stored in the second pairing buffer; and a second system decoder configured to decode the system information stored in the second system buffer.

The first communication network may correspond to a broadcasting network, and the second communication network may correspond to an Internet protocol (IP) communication network.

The first receiver may include the hybrid buffer.

According to another aspect of embodiments, there is provided a video reception apparatus, including: a first receiver configured to receive a base video over a first communication network; a second receiver configured to receive an auxiliary video over a second communication network; and a file buffer configured to store the auxiliary video in advance prior to receiving the base video.

The video reception apparatus may further include a processing unit configured to insert the same PTS into the base video and the auxiliary video.

The processing unit may process the base video and the auxiliary video based on the PTS to output the base video and the auxiliary video as a single stereoscopic video.

The first receiver may include: a first video buffer configured to store a video elementary stream corresponding to the base video; an audio buffer configured to store an audio elementary stream corresponding to the base video; a first pairing buffer configured to store media pairing information for synchronizing the base video with the auxiliary video; and a first system buffer configured to store system information corresponding to the base video and on a program that is in a decoding process.

The first receiver may further include: a first video decoder configured to decode the video elementary stream; an audio decoder configured to decode the audio elementary stream; a first pairing decoder configured to decode the media pairing information stored in the first pairing buffer; and a first system decoder configured to decode the system information stored in the first system buffer.

The second receiver may include: a second video buffer configured to store a video elementary stream corresponding to the auxiliary video; and a second system buffer configured to store system information corresponding to the auxiliary video and on a program that is in a decoding process.

The second receiver may further include: a second video decoder configured to decode the video elementary stream corresponding to the auxiliary video; and a second system decoder configured to decode the system information stored in the second system buffer.

The first communication network may correspond to a broadcasting network, and the second communication network may correspond to an IP communication network.

The second receiver may include the file buffer.

### BRIEF DESCRIPTION OF THE DRAWINGS

These and/or other aspects, features, and advantages of the embodiments will become apparent and more readily appreciated from the following description of exemplary embodiments, taken in conjunction with the accompanying drawings of which:

FIG. 1 illustrates a buffer model and a timing for a hybrid three-dimensional television (3DTV) broadcasting service according to an embodiment;

FIG. 2 is a block diagram illustrating a configuration of a transport and reception system of hybrid 3DTV content according to an embodiment;

FIG. 3 illustrates a video reception apparatus to perform streaming of hybrid 3DTV content according to an embodiment; and

FIG. 4 illustrates a video reception apparatus to process downloaded hybrid 3DTV content according to an embodiment.

### DETAILED DESCRIPTION

Reference will now be made in detail to exemplary embodiments, examples of which are illustrated in the accompanying drawings, wherein like reference numerals refer to like elements throughout. Exemplary embodiments are described below to explain the present disclosure by referring to the figures.

Hereinafter, embodiments will be described with reference to the accompanying drawings.

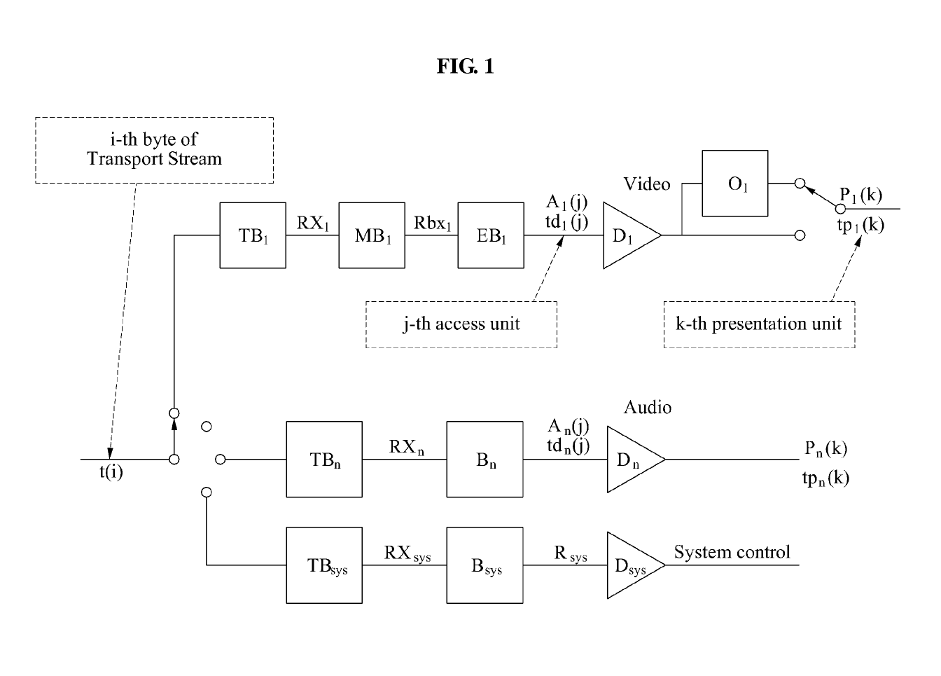

FIG. 1 illustrates a buffer model and a timing for a hybrid three-dimensional television (3DTV) broadcasting service according to an embodiment;

Here, the buffer model and the timing for the hybrid 3DTV broadcasting service of

FIG. 1 may be based on, for example, a transport stream system target decoder (T-STD) model of International Organization for Standardization/International Electromechanical Commission (ISO/IEC) 13818-1:2013.

In this example, in a case in which a separate delay does not occur in an Internet protocol (IP) communication network, for example, in a case in which a transport delay is absent, an existing digital TV (DTV) buffering and timing model may be applied as is. For example, in a case in which the separate delay is absent in the IP communication network, a corresponding video in the IP communication network may have the same presentation time stamp (PTS) as an existing base video.

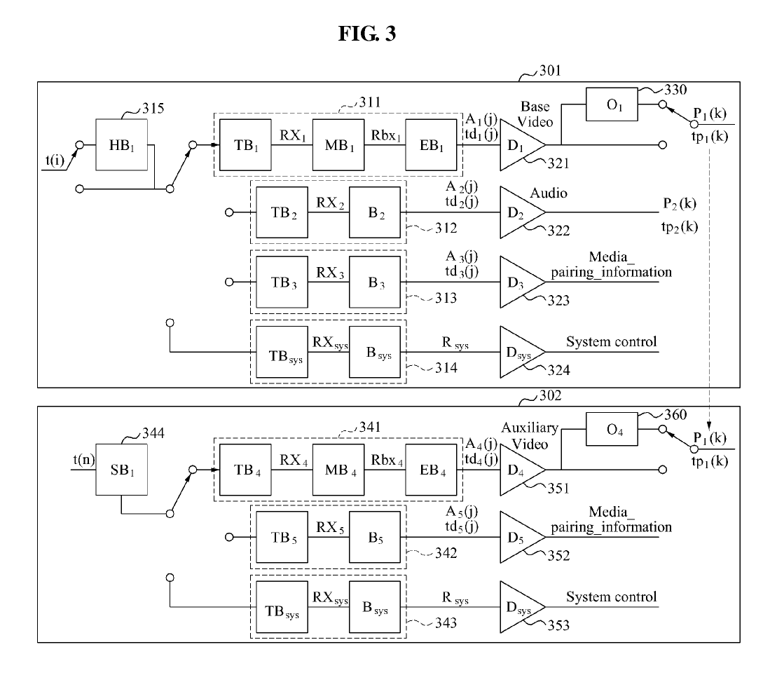

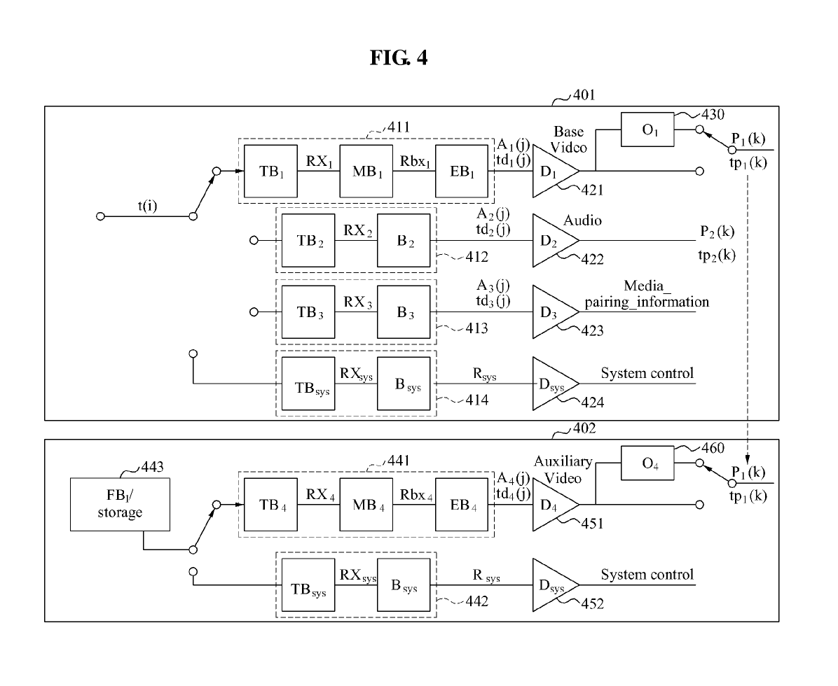

Notations used in the T-STD model of FIG. 1 may be represented as follows, which may be used as the same meanings in FIGS. 3 and 4.

i denotes an index of a byte in a transport stream (TS). For example, a first byte may have an index of “0”.

j denotes an index of an access unit (AU) in an elementary stream (ES).

k denotes an index of a presentation unit in an elementary stream.

n denotes an index of an elementary stream.

t(i) denotes a time, for example, a unit of second at which an i-th bye of a transport stream enters an STD. For example, a value of t(0) may be an arbitrary constant. The STD model may represent a virtual model of a decoding process employed when describing semantics of ISO/IEC 13818-1 multiplexing bitstream.

Aₙ(j) denotes a j-th access unit in an elementary stream n. Here, Aₙ(j) may be indexed in a decoding order. AU may express a coded representation of a unit desired to be played back. For example, in the case of an audio, AU may refer to all the coded data of a single audio frame. In the case of a video, AU may refer to a stuffing portion and all the coded data of a single picture.

tdₙ(j) denotes a decoding time, measured based on a unit of second, in an STD of a j-th access unit in an elementary stream n.

Pₙ(k) denotes a k-th presentation unit in an elementary stream n. Pₙ(k) may result from decoding Aₙ(j). Pₙ(k) may be indexed in a presentation order.

tpₙ(k) denotes a presentation time, measured based on a unit of second, in an STD of a k-th presentation unit in an elementary stream n.

Bₙ denotes a main buffer for an elementary stream n. Here, Bₙ may be present only for an audio elementary stream.

B_{sys} denotes a main buffer in an STD for system information on a program that is in a decoding process.

MBₙ denotes a multiplexing buffer for an elementary stream n. Here, MBₙ may be present only for a video elementary stream.

EBₙ denotes an elementary stream buffer for an elementary stream n. Here, EBₙ may be present only for a video elementary stream.

TB_{sys} denotes a transport buffer for system information on a program that is in a decoding process.

TBₙ denotes a transport buffer for an elementary stream n.

D_{sys} denotes a decoder for system information in a program stream n.

Dₙ denotes a decoder for an elementary stream n.

Oₙ denotes a reorder buffer for a video elementary stream n.

R_{sys} denotes a rate at which data is removed from the main buffer B_{sys}.

Rxₙ denotes a rate at which data is removed from the transport buffer TBₙ.

Rbxₙ denotes a rate at which packetized elementary stream (PES) packet payload data is removed from the multiplexing buffer MBₙ when a leak method is used. Here, Rbxₙ may be defined only for a video elementary stream.

Rx_{sys} denotes a rate at which data is removed from the transport buffer TB_{sys}.

p denotes an index of a transport stream packet in a transport stream.

PCR(i) denotes a time encoded in a program clock reference (PCR) field measured based on a unit of a period of a 27-MHz system clock. Here, i denotes a byte index of a final byte in a program_clock_reference_base field.

t denotes a time measured based on a unit of second.

Fₙ (t) denotes a fullness, measured in bytes, of an STD input buffer for an elementary stream n at a time t.

BSₙ denotes a size of the buffer Bₙ measured based on a byte unit.

BS_{sys} denotes a size of the buffer B_{sys} measured based on a byte unit.

MBSₙ denotes a size of the multiplexing buffer MBₙ measured based on a byte unit.

EBSₙ denotes a size of the elementary stream buffer EBₙ measured based on a byte unit.

TBS_{sys} denotes a size of the transport buffer TB_{sys} measured based on a byte unit.

TBSₙ denotes a size of the transport buffer TBₙ measured based on a byte unit.

Rbxₙ(j) denotes a rate at which PES packet payload data is removed from MBₙ in a case in which a vbv_delay method is used.

Rₑₛ denotes a rate at which a video elementary stream is coded in a sequence header.

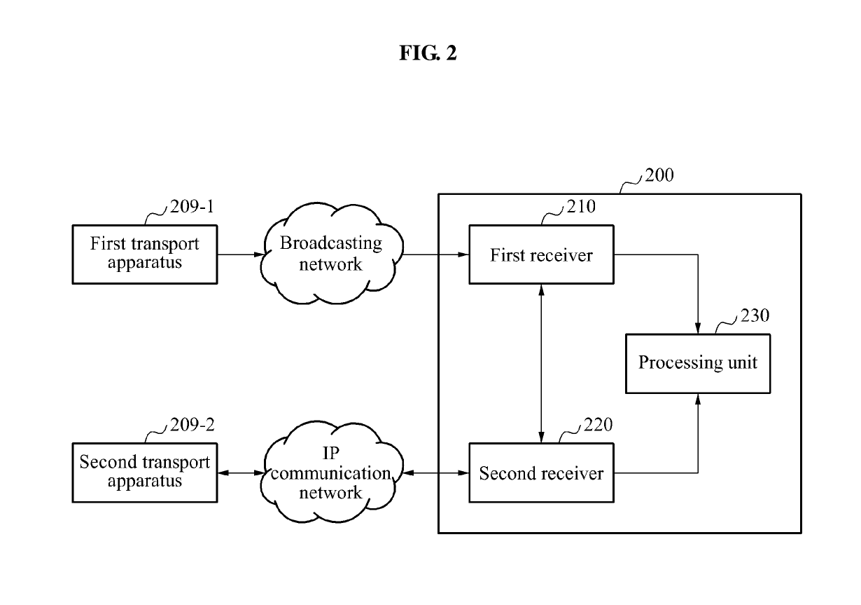

FIG. 2 is a block diagram illustrating a configuration of a transport and reception system of hybrid 3DTV content according to an embodiment.

Referring to FIG. 2, in the transport and reception system, a video reception apparatus 200 may include a first receiver 210, a second receiver 220, and a processing unit 230. Here, the video reception apparatus 200 may receive hybrid 3DTV content via different paths, for example, a broadcasting network and an IP communication network. The hybrid 3DTV content may include a program, for example, a video and an audio coded according to a moving picture experts group-2 (MPEG-2) standard method.

In detail, the first receiver 210 may receive a base video from a first transport apparatus 209-1 over a first communication network. The second receiver 220 may receive an auxiliary video from a second transport apparatus 209-2 over a second communication network. For example, the first communication network may correspond to a broadcasting network, and the second communication network may correspond to an IP communication network. Also, the base video and the auxiliary video may correspond to a single set of 3DTV content.

In the present specification, a service of processing and servicing all of data, for example, a base video and an auxiliary video transmitted via different paths, for example, a broadcasting network and an IP communication network may be referred to as a hybrid service.

For example, to service a large amount of 3D content or high quality content, a processing volume of an existing broadcasting transport and reception system may be limited. Accordingly, the hybrid service may be provided to be compatible with the existing broadcasting system and reception apparatus and to be capable of servicing a large amount of content. The hybrid service may provide a single set of content using a plurality of different networks and thus, may also process a large amount of content. Although an example of employing the broadcasting network and the IP communication network is described herein, types of networks and the number of networks may be variously embodied without being limited thereto.

The processing unit 230 may synchronize the auxiliary video with the base video based on media pairing information received over at least one of the first communication network and the second communication network, and may insert the same PTS into the base video and the auxiliary video. Also, the processing unit 230 may process the base video and the auxiliary video based on the PTS to output the base video and the auxiliary video as a single stereoscopic video.

In this example, the PTS may refer to information used to designate a time at which the video reception apparatus 200 is to decode and then output a video signal or an audio signal, in order to solve an issue that video and audio mismatch due to an amount of time used for compressing and restoring the video signal being greater than an amount of time used for compressing and restoring the audio signal, in the case of compressing and transmitting the video signal and the audio signal according to an MPEG-2 standard. The PTS may be carried in a header of each sequence and thereby transmitted. Also, the PTS may be expressed as a difference value with a program clock reference (PCR) that is reference time information.

FIG. 3 illustrates a video reception apparatus to perform streaming of hybrid 3DTV content according to an embodiment.

A first receiver 301 according to an embodiment may include a first video buffer 311 configured to store a video elementary stream corresponding to a base video, an audio buffer 312 configured to store an audio elementary stream corresponding to the base video, a first pairing buffer 313 configured to store media pairing information for synchronizing the base video with the auxiliary video, a first system buffer 314 configured to store system information corresponding to the base video and on a program that is in a decoding process, and a hybrid buffer 315. Referring to FIG. 3, the first video buffer 311 may include, for example, TB₁, MB₁, and EB₁, the audio buffer 312 may include, for example, TB₂ and B₂, the first pairing buffer 313 may include, for example, TB₃ and B₃, the first system buffer 314 may include, for example, TB_{sys} and B _{sys}, and the hybrid buffer 315 may include HB₁.

The hybrid buffer 315 may compensate for a delay occurring in the auxiliary video based on a communication state of the second communication network, with respect to the base video. For example, the hybrid buffer 315 may delay the base video by the delay that has occurred in the auxiliary video.

Also, the first receiver 301 may further include a first video decoder 321, for example, D₁, configured to decode the video elementary stream, an audio decoder 322, for example, D₂, configured to decode the audio elementary stream, a first pairing decoder 323, for example, D₃, configured to decode the media pairing information stored in the first pairing buffer 313, and a first system decoder 324, for example, D_{sys}, configured to decode the system information stored in the first system buffer 314. The first receiver 301 may include a first reorder buffer 330, for example, O₁, configured to reorder the decoded video elementary stream.

A second receiver 302 according to an embodiment may include a second video buffer 341 configured to store a video elementary stream corresponding to an auxiliary video, a second pairing buffer 342 configured to store media pairing information for synchronizing the auxiliary video with the base video, a second system buffer 343 configured to store system information corresponding to the auxiliary video and on a program that is in a decoding process, and a streaming buffer 344 configured to store the auxiliary video. Referring to FIG. 3, the second video buffer 341 may include, for example, TB₄, MB₄, and EB₄, the second pairing buffer 342 may include, for example, TB₅ and B₅, the second system buffer 343 may include, for example, TB_{sys} and B_{sys}, and the streaming buffer 344 may include SB₁.

Also, the second receiver 302 may further include a second video decoder 351, for example, D₄, configured to decode the video elementary stream corresponding to the auxiliary video, a second pairing decoder 352, for example, D₅, configured to decode the media pairing information stored in the second pairing buffer 342, and a second system decoder 353, for example, D_{sys}, configured to decode the system information stored in the second system buffer 343. The second receiver 302 may include a second reorder buffer 360, for example, O₄, configured to reorder the decoded video elementary stream.

According to an embodiment, in the case of an auxiliary video stream transmitted over an IP communication network, predetermined delay may occur based on a communication state of the IP communication network. In this example, to synchronize and play back a base video and an auxiliary video, the hybrid buffer 315 configured to buffer a time difference of the base video to be broadcasted may be applied to the first receiver 301 as illustrated in FIG. 3. A base video stream may follow a procedure of an ISO/IEC 13818-1 T-STD model applied to an existing DTV. Also, in the case of a general two-dimensional (2D) broadcasting service, the hybrid buffer 315 may not be applied.

According to an embodiment, media pairing information transmitted over a broadcasting network and an IP communication network may be performed through the same procedure based on an existing DTV model.

According to an embodiment, an auxiliary video stored in a streaming buffer may be synchronized with a base video that has passed through a decoder by a processing unit, based on media pairing information. The processing unit may insert the same PTS as the base video into the auxiliary video and may output the auxiliary video and the base video as a stereoscopic video based on the PTS using a renderer (not shown).

For example, the processing unit may synchronize an auxiliary video with a base video based on media pairing information received over at least one of a first communication network and a second communication network. Also, the processing unit may process the base video and the auxiliary video based on the PTS to output the base video and the auxiliary video as a single stereoscopic video.

According to an embodiment, in a case in which an auxiliary video is provided in a type of an MPEG-2 TS and a synchronization type is a PES level, media pairing information may include media pairing information pᵢ(j) for synchronizing and playing back a base video and an auxiliary video. Here, pᵢ(j) denotes j-th media pairing information.

FIG. 4 illustrates a video reception apparatus to process downloaded hybrid 3DTV content according to an embodiment.

According to an embodiment, a first video buffer 411, an audio buffer 412, a first pairing buffer 413, and a first system buffer 414 of FIG. 4 may be similar to the first video buffer 311, the audio buffer 312, the first pairing buffer 313, and the first system buffer 314 of FIG. 3. Also, a first video decoder 421, an audio decoder 422, a first pairing decoder 423, a first system decoder 424, and a first reorder buffer 430 of FIG. 4 may be similar to the first video decoder 321, the audio decoder 322, the first pairing decoder 323, the first system decoder 324, and the first reorder buffer 330 of FIG. 3.

According to an embodiment, a first receiver 401 of FIG. 4 may include the first video buffer 411, the audio buffer 412, the first pairing buffer 413, the first system buffer 414, the first video decoder 421, the audio decoder 422, the first pairing decoder 423, the first system decoder 424, and the first reorder buffer 430.

According to an embodiment, a second video buffer 441 and a second system buffer 442 of FIG. 4 may be similar to the second video buffer 341 and the second system buffer 343 of FIG. 3. Also, a second video decoder 451, a second system decoder 452, and a second reorder buffer 460 of FIG. 4 may be similar to the second video decoder 351, the second system decoder 353, and the second reorder buffer 360 of FIG. 3.

According to an embodiment, a second receiver 402 of FIG. 4 may include the second video buffer 441, the second system buffer 442, the second video decoder 451, the second system decoder 452, and the second reorder buffer 460. Also, the second receiver 402 may further include a file buffer 443, for example, FB₁/storage, configured to store the auxiliary video in advance prior to receiving the base video. For example, the file buffer 443 may be replaced with a local storage. Here, FBₙ denotes a file buffer for a file n.

According to an embodiment, a hybrid 3DTV download service may store, in a file buffer or a local storage, an auxiliary video stream transmitted over an IP communication network, prior to storing a base video stream. In a case in which the auxiliary video stream is stored prior to storing the base video stream, the base video stream may be processed through a procedure of an ISO/IEC 13818-1 T-STD model applied to the existing DTV.

According to an embodiment, media pairing information transmitted over a broadcasting network may be processed through a procedure that is based on an existing DTV model.

According to an embodiment, the same PTS as the base video having passed through a decoder may be inserted into the auxiliary video stored in the file buffer 443. The processing unit may output the auxiliary video and the base video as a stereoscopic video based on the PTS using a renderer (not shown).

For example, the processing unit may insert the same PTS into a base video and an auxiliary video. The processing unit may process the base video and the auxiliary video based on the PTS to output the base video and the auxiliary video as a single stereoscopic video.

According to embodiments, a video reception apparatus may synchronize hybrid 3DTV contents received over a broadcasting network and an IP communication network, and may output the same as a stereoscopic video.

According to embodiments, a video reception apparatus may synchronize a base video and an auxiliary video by compensating for a delay occurring in an IP communication network using a hybrid buffer.

According to embodiments, a video reception apparatus may synchronize a base video and an auxiliary video that is stored in advance in a file buffer or a local storage.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing to configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

Although a few exemplary embodiments have been shown and described, the present disclosure is not limited to the described exemplary embodiments. Instead, it would be appreciated by those skilled in the art that changes may be made to these exemplary embodiments without departing from the principles and spirit of the present disclosure, the scope of which is defined by the claims and their equivalents.

What is claimed is:

1. A video reception apparatus, comprising:
a first receiver configured to receive a base video over a first communication network;
a second receiver configured to receive an auxiliary video over a second communication network; and
a hybrid buffer configured to compensate for a delay occurring in the auxiliary video based on a communication state of the second communication network, with respect to the base video.

2. The video reception apparatus of claim 1, further comprising:
a processing unit configured to synchronize the auxiliary video with the base video based on media pairing information received over at least one of the first communication network and the second communication unit, and to insert the same presentation time stamp (PTS) into the base video and the auxiliary video.

3. The video reception apparatus of claim 2, wherein the processing unit is configured to process the base video and the auxiliary video based on the PTS to output the base video and the auxiliary video as a single stereoscopic video.

4. The video reception apparatus of claim 1, wherein the second receiver comprises a streaming buffer configured to sore the auxiliary video.

5. The video reception apparatus of claim 1, wherein the first receiver comprises:
a first video buffer configured to store a video elementary stream corresponding to the base video;
an audio buffer configured to store an audio elementary stream corresponding to the base video;
a first pairing buffer configured to store media pairing information for synchronizing the base video with the auxiliary video; and
a first system buffer configured to store system information corresponding to the base video and on a program that is in a decoding process.

6. The video reception apparatus of claim 5, wherein the first receiver further comprises:
a first video decoder configured to decode the video elementary stream;
an audio decoder configured to decode the audio elementary stream;
a first pairing decoder configured to decode the media pairing information stored in the first pairing buffer; and
a first system decoder configured to decode the system information stored in the first system buffer.

7. The video reception apparatus of claim 1, wherein the second receiver comprises:
a second video buffer configured to store a video elementary stream corresponding to the auxiliary video;
a second pairing buffer configured to store media pairing information for synchronizing the auxiliary video with the base video; and
a second system buffer configured to store system information corresponding to the auxiliary video and on a program that is in a decoding process.

8. The video reception apparatus of claim 7, wherein the second receiver further comprises:
a second video decoder configured to decode the video elementary stream corresponding to the auxiliary video;
a second pairing decoder configured to decode the media pairing information stored in the second pairing buffer; and
a second system decoder configured to decode the system information stored in the second system buffer.

9. The video reception apparatus of claim 1, wherein the first communication network corresponds to a broadcasting network, and
the second communication network corresponds to an Internet protocol (IP) communication network.

10. The video reception apparatus of claim 1, wherein the first receiver comprises the hybrid buffer.

11. A video reception apparatus, comprising:
a first receiver configured to receive a base video over a first communication network;
a second receiver configured to receive an auxiliary video over a second communication network; and
a file buffer configured to store the auxiliary video in advance prior to receiving the base video.

12. The video reception apparatus of claim 11, further comprising:
a processing unit configured to insert the same presentation time stamp (PTS) into the base video and the auxiliary video.

13. The video reception apparatus of claim 12, wherein the processing unit is configured to process the base video and the auxiliary video based on the PTS to output the base video and the auxiliary video as a single stereoscopic video.

14. The video reception apparatus of claim 11, wherein the first receiver comprises:
a first video buffer configured to store a video elementary stream corresponding to the base video;
an audio buffer configured to store an audio elementary stream corresponding to the base video;
a first pairing buffer configured to store media pairing information for synchronizing the base video with the auxiliary video; and
a first system buffer configured to store system information corresponding to the base video and on a program that is in a decoding process.

15. The video reception apparatus of claim 14, wherein the first receiver further comprises:
a first video decoder configured to decode the video elementary stream;
an audio decoder configured to decode the audio elementary stream;
a first pairing decoder configured to decode the media pairing information stored in the first pairing buffer; and
a first system decoder configured to decode the system information stored in the first system buffer.

16. The video reception apparatus of claim 11, wherein the second receiver comprises:
a second video buffer configured to store a video elementary stream corresponding to the auxiliary video; and
a second system buffer configured to store system information corresponding to the auxiliary video and on a program that is in a decoding process.

17. The video reception apparatus of claim 16, wherein the second receiver further comprises:
a second video decoder configured to decode the video elementary stream corresponding to the auxiliary video; and
a second system decoder configured to decode the system information stored in the second system buffer.

18. The video reception apparatus of claim 11, wherein the first communication network corresponds to a broadcasting network, and
the second communication network corresponds to an Internet protocol (IP) communication network.

19. The video reception apparatus of claim 11, wherein the second receiver comprises the file buffer.
